(19) United States
(12) Patent Application Publication
(10) Pub. No.: US 2008/0213644 A1
(43) Pub. Date: Sep. 4, 2008

(54) SOLID POLYELECTROLYTE TYPE FUEL CELL AND METHOD OF PRODUCING THE SAME

(75) Inventors: Taisuke SHINDOH, Tsu-shi (JP); Tsutomu Takatera, Albuquerque, NM (US)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/960,013

(22) Filed: Dec. 19, 2007

(30) Foreign Application Priority Data
Dec. 25, 2006 (JP) 2006-347490

(51) Int. Cl. H01M 8/10; B05D 5/12; B29C 65/02

(52) U.S. Cl. 429/30; 427/115; 156/60

(57) ABSTRACT

To provide a solid polyelectrolyte type fuel cell having excellent reliability and a method of producing the same by reducing electric interface resistance between an electrode and a solid polyelectrolyte membrane by improving contact area and cohesion between the electrode and the solid polyelectrolyte membrane. The present invention relates to a solid polyelectrolyte type fuel cell including a polyelectrolyte membrane and a pair of electrodes sandwiching the polyelectrolyte membrane, and the electrodes have a catalyst layer containing catalyst-carrying carbon particles, and at least one surface of the polyelectrolyte membrane has a bumpy face in which a bumpy shape is formed, and the catalyst layer is formed in close contact with the bumpy shape of the bumpy face.

This nonprovisional application is based on Japanese Patent Application No, 2006-347490 filed with the Japan Patent Office on Dec. 25, 2006, the entire contents of which are hereby incorporated by reference.

### BACKGROUND OF THE INVENTION

1. Field of the Invention

The present invention relates to a solid polyelectrolyte type fuel cell having excellent reliability and a method of producing the same.

2. Description of the Background Art

Various kinds of fuel cells are known such as one of a phosphate type, and in recent years, development of solid polymer type fuel cells using a solid electrolyte membrane as an electrolyte, in particular, is actively made. A solid polyelectrolyte type fuel cell includes a proton-conductive solid polyelectrolyte formed of, e.g., a perfluorosulfonate membrane, and a pair of electrodes, namely, an anode and a cathode which are opposite to each other via the solid polyelectrolyte. The anode is supplied with fuel such as pure hydrogen, methanol or fossil fuel while the cathode is supplied with oxygen or air, to thereby cause electrochemical reactions for generating power. The electrochemical reactions occurring in these electrodes are expressed as follows.

For instance, when a fuel electrode (anode) is supplied with hydrogen and an air electrode (cathode) is supplied with oxygen, the following electrochemical reactions proceed:

anode: H₂→2H⁺+2e⁻

cathode: 1/2O₂+2H⁺2e⁻→H₂O

Alternatively, the fuel electrode may be supplied with methanol instead of hydrogen to allow operation directly as a methanol type fuel cell. In such a case, the following electrochemical reactions proceed:

anode: CH₃OH+H₂O→6H⁺+6e⁻+CO₂

cathode: 3/2O₂+6H⁺+6e⁻→3H₂O

In this manner, since the reactions at the respective electrodes proceed only at a three-phase interface where both donation and reception of protons (H⁺) and electrodes (e⁻) can be performed, an area occupied by the three-phase interface will greatly influence on performance of the fuel cell.

Generally, as an electrode of a solid polyelectrolyte type fuel cell, a mixture of catalyst-carrying carbon particles in which catalyst metal of platinum or platinum alloy is carried on carbon particles in highly dispersed manner, and an ion-conductive polyelectrolyte is mainly used. Such electrodes are manufactured by mixing the catalyst-carrying carbon particles and a polyelectrolyte dispersion solution dissolved in an organic solvent to make a paste, and applying the paste onto an electrode base made of a conductive porous material such as carbon paper by screen printing, spray coating, doctor blade methods or the like. By sandwiching a polyelectrolyte membrane between a pair of electrodes thus manufactured, and bonding by thermocompression, a fuel cell is formed.

FIG. 6 includes section views for illustrating a conventional joining method of a polyelectrolyte membrane and an electrode. A polyelectrolyte membrane 1 and an electrode 2 are overlaid together (FIG. 6A), and are bonded by thermocompression to join polyelectrolyte membrane 1 and electrode 2 (FIG. 6B). However, when a surface of polyelectrolyte membrane 1 is processed to have a bumpy shape as shown in FIG. 6, interface resistance between the polyelectrolyte membrane and the electrode may possibly increase because polyelectrolyte membrane 1 and electrode 2 are partially out of contact with each other.

As a method of improving characteristics of the fuel cell configured as described above, there are known the followings: increasing the amount of the catalyst in the electrodes for promoting a chemical reaction between hydrogen or methanol and oxygen gas in order to increase the area of the three-phase interface; imparting excellent gas diffusivity to the electrodes for feeding a sufficient amount of reaction gas to the catalyst; and improving proton conductivity in flowing from the anode to the cathode of hydrogen ions generated by the chemical reaction at the electrode. It is particularly important to reduce the interface resistance between the electrode and the polyelectrolyte membrane.

Methods of reducing the interface resistance between the electrode and the polyelectrolyte membrane include a method of increasing a contact area between the catalyst and the electrolyte membrane, and a method of increasing cohesion between the catalyst and the electrolyte membrane. In general, since a polyelectrolyte membrane will swell due to containment of water, the electrode and the polyelectrolyte membrane tend to easily come off from each other. When the cohesion between the electrode and the polyelectrolyte membrane is poor, there arises a problem of reduction in reliability.

In such conventional production methods, the use efficiency of catalyst carried on carbon particles is low in the aforementioned three-phase interface, and a large quantity of catalyst fails to function effectively in electrochemical reaction, so that catalyst activity for electrochemical reaction at the electrodes is low. This is attributable to the fact that the polyelectrolyte is unable to penetrate inside micropores of carbon particles which are carriers because the polyelectrolyte solution has certain viscosity, and particle sizes of ionomer of polyelectrolyte dispersed in the solution are large, and it is impossible to make the polyelectrolyte into contact with the catalyst metal carried inside the micropores. Accordingly, there is a large quantity of catalyst metal that is not in contact with polyelectrolyte, and hence is unable to be involved in electrochemical reaction at the electrode, so that catalyst use efficiency of catalyst decreases.

Japanese Patent Laying-Open No. 09-092293 proposes an electrode for a solid polyelectrolyte type fuel cell, in which specific volume of pores having a diameter ranging from 0.04 to 1.0 μm in the catalyst layer is not less than 0.04 cm³.

Japanese Patent Laying-Open No. 2000-100448 proposes a catalyst for a polymer solid electrolyte type fuel cell, in which noble metal is carried by carbon micropowder having not more than 20% of micropores having diameter of not more than 60 angstroms, to the entire micropores. In other words, Patent Document 1 and Patent Document 2 attempt to control the amount of catalyst that fails to function effectively by selecting carbon particles of catalyst carrier having less micropores.

Japanese Patent Laying-Open No. 2000-228204 proposes to increase use efficiency of catalyst by forming a diffusion layer of hydrogen ion by chemical absorption of silane compound on the surface of the catalyst carrier, and forming a unimolecular diffusion layer of hydrogen ion on the surface of the catalyst inside micropores.

Also proposed is a technique of increasing the composition ratio of polyelectrolyte component, relative to catalyst carrier carbon particles in the catalyst layer, in order to improve ion conductivity inside an electrode. Also proposed is a technique of improving cohesion between an electrode and a solid polyelectrolyte membrane in order to reduce the interface resistance between the electrode and the solid polyelectrolyte membrane.

Japanese Patent Laying-Open No. 03-167752 proposes a gas diffusion electrode including a reaction membrane that is in contact with electrolyte and a gas diffusion membrane joined with the reaction membrane, the gas diffusion electrode having a bumpy face on the side of the reaction membrane. Japanese Patent Laying-Open No. 2003-317735 proposes a fuel cell that includes a solid polyelectrolyte membrane having a bumpy face, and a catalyst electrode joined with the bumpy face of the solid polyelectrolyte membrane. Japanese Patent Laying-Open No. 2004-006306 proposes a fuel cell that includes a catalyst electrode including a first solid polyelectrolyte membrane and a catalyst substance, a solid polyelectrolyte membrane, and an adhesive layer including a second polyelectrolyte disposed between the catalyst electrode and the solid polyelectrolyte membrane.

As is the above technique, when a bumpy face is formed on the surface of the solid polyelectrolyte membrane, a bumpy face having fine and deep grooves is provided in order to make the surface area of the solid polyelectrolyte membrane as large as possible. In such a case, however, due to the complexity of the shape of the bumpy face, the contact area between the electrode that is connected to the solid polyelectrolyte membrane by e.g., thermocompression bonding, and the solid polyelectrolyte membrane is small, so that it is difficult to sufficiently make use of advantage of providing a bumpy face on the surface of the solid polyelectrolyte membrane. When an adhesive layer made of polymer is provided between the electrode and the solid polyelectrolyte, the problem of large electric resistance arises in association with the increased thickness of the electrolyte membrane.

For the reasons as described above, according to the conventional techniques, the effect of improving catalyst performance to such an extent that is enough to improve characteristics of fuel cell is not expected although the use efficiency of catalyst can be improved to some extent by reducing the amount of catalyst that fails to effectively contribute to the reaction.

### SUMMARY OF THE INVENTION

It is an object of the present invention to solve the above problems, and to provide a solid polyelectrolyte type fuel cell having excellent reliability and a method of producing the same, by reducing electric interface resistance between an electrode and a solid polyelectrolyte membrane by improving contact area and cohesion between the electrode and the solid polyelectrolyte membrane.

The present invention relates to a solid polyelectrolyte type fuel cell including a polyelectrolyte membrane and a pair of electrodes sandwiching the polyelectrolyte membrane, wherein the electrodes have a catalyst layer containing catalyst-carrying carbon particles, at least one surface of the polyelectrolyte membrane has a bumpy face in which a bumpy shape is formed, and the catalyst layer is formed in contact with the bumpy shape of the bumpy face.

In the solid polyelectrolyte type fuel cell according to the present invention, preferably, the catalyst layer formed on the bumpy face contains catalyst-carrying carbon particles having surfaces modified with a proton dissociative functional group or an organic compound having the proton dissociative functional group.

In the solid polyelectrolyte type fuel cell according to the present invention, preferably, the catalyst layer formed on the bumpy face includes a first catalyst layer formed in contact with the polyelectrolyte membrane, and a second catalyst layer formed to be opposite to the polyelectrolyte membrane via the first catalyst layer.

In the solid polyelectrolyte type fuel cell according to the present invention, preferably, of the first catalyst layer and the second catalyst layer, only the first catalyst layer contains catalyst-carrying carbon particles having surfaces modified with a proton dissociative functional group or an organic compound having the proton dissociative functional group.

In the solid polyelectrolyte type fuel cell according to the present invention, preferably, the catalyst-carrying carbon particles subjected to surface modification has a specific surface area of not less than 900 m²/g.

In the solid polyelectrolyte type fuel cell according to the present invention, preferably, surface roughness on the bumpy face of the polyelectrolyte membrane is not less than 1 μm by average roughness (Ra).

The present invention also relates to a method of producing the solid polyelectrolyte type fuel cell described above, including a bumpy face forming step for forming the bumpy face on at least one surface of the polyelectrolyte membrane, a catalyst-carrying carbon particles preparing step for preparing catalyst-carrying carbon particles by making carbon particles carry catalyst; an applying step for directly applying catalyst paste containing catalyst-carrying carbon particles to at least the bumpy face of the polyelectrolyte membrane; and a drying step for drying the catalyst paste to form the catalyst layer containing the catalyst-carrying carbon particles.

In the method of producing the solid polyelectrolyte type fuel cell according to the present invention, preferably, the catalyst layer formed on the bumpy face contains catalyst-carrying carbon particles having surfaces modified with a proton dissociative functional group or an organic compound having the proton dissociative functional group.

In the method of producing the solid polyelectrolyte type fuel cell according to the present invention, preferably, the catalyst layer formed on the bumpy face includes a first catalyst layer formed in contact with the polyelectrolyte membrane, and a second catalyst layer formed to be opposite to the polyelectrolyte membrane via the first catalyst layer, and the first layer is formed by the applying step and the drying step, and the method further includes the step of joining the second catalyst layer to the surface of the first catalyst layer by thermocompression bonding.

In the method of producing the solid polyelectrolyte type fuel cell according to the present invention, preferably, of the first catalyst layer and the second catalyst layer, only the first catalyst layer contains catalyst-carrying carbon particles having surfaces modified with a proton dissociative functional group or an organic compound having the proton dissociative functional group.

According to the present invention, by making at least one surface of the polyelectrolyte membrane as the bumpy face, and forming a catalyst layer so as to be close contact with the bumpy shape, it is possible to increase the contact area between the catalyst layer and the polyelectrolyte membrane, and to improve cohesion between the catalyst layer and the polyelectrolyte membrane. Accordingly, the interface resistance between the catalyst layer and the polyelectrolyte membrane is reduced, and a fuel cell of high reliability can be obtained.

The solid polyelectrolyte type fuel cell of the present invention is suitably used as a power supply for portable small-sized devices, or electric devices used in areas where commercial power supply is not available, for example.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a section view showing a representative structure of a solid polyelectrolyte type fuel cell according to the present invention.

FIG. 2 is a schematic view of a section form of a joined member observed in Comparative Example 3.

FIG. 3 is a view showing results of power generation tests of solid polyelectrolyte type fuel cells produced in Example 1 and Comparative Examples 1 to 3.

FIG. 4 is a view showing results of power generation tests of solid polyelectrolyte type fuel cells produced in Examples 2 to 7 and Comparative Examples 4 and 5.

FIG. 5 is a view showing results of power generation tests of solid polyelectrolyte type fuel cells produced in Example 8 and Comparative Examples 6 to 8.

FIG. 6 includes section views for describing a conventional method of joining a polyelectrolyte membrane and an electrode.

### DESCRIPTION OF THE PREFERRED EMBODIMENTS

### [Solid Polyelectrolyte Type Fuel Cell]

A solid polyelectrolyte type fuel cell of the present invention includes a polyelectrolyte membrane and a pair of electrodes sandwiching the polyelectrolyte membrane, and the electrodes have a catalyst layer containing catalyst-carrying carbon particles. At least one surface of the polyelectrolyte membrane has a bumpy face formed into a bumpy shape, and the catalyst layer is formed in close contact with the bumpy shape of the bumpy face. In other words, in the fuel cell of the present invention, cohesion between the catalyst layer and the polyelectrolyte membrane is improved by increasing contact area between the catalyst layer and the polyelectrolyte membrane in at least one of an anode electrode and a cathode electrode. Therefore, according to the present invention, it is possible to significantly reduce the interface resistance between the electrode and the polyelectrolyte membrane, so that it is possible to improve the power generation characteristics and reliability of the fuel cell.

FIG. 1 is a section view showing a representative structure of a solid polyelectrolyte type fuel cell according to the present invention, A fuel cell 100 shown in FIG. 1 has an anode-side electrode 2 and a cathode-side electrode 3 that sandwich a polyelectrolyte membrane 1. The anode-side electrode and the cathode-side electrode may also be referred to as an anode electrode and a cathode electrode, respectively. Electrodes 2, 3 respectively include catalyst layers 21, 31 and diffusion layers 22, 32. Outside electrodes 2, 3 there are provided separators 4, 5, and separators 4, 5 are formed with flow channels for allowing communication of reaction substances generating at the anode electrode and the cathode electrode. Output from fuel cell 100 is taken outside by connection between separators 4, 5 and an external circuit 6.

FIG. 1 shows a case where separators 4 and 5 are used as electron collectors. However, a metal net or the like may be formed as an electron collector.

An anode electrode of fuel cell 100 is supplied with fuel such as methanol aqueous solution or hydrogen as shown by arrow A1. For example, when methanol aqueous solution is supplied as the fuel, an unreacted methanol aqueous solution and carbon dioxide are discharged from the anode electrode as shown by arrow A2. When hydrogen is supplied as the fuel, unreacted hydrogen is discharged from the anode electrode as shown by arrow A2.

A cathode electrode of fuel cell 100 is supplied with oxygen source such as air as shown by arrow A3. For example, when air is supplied to the anode electrode, water and air is discharged from the anode as shown by arrow A4.

### <Electrode>

An electrode formed in the present invention includes at least a catalyst layer, and more typically includes a diffusion layer formed of a conductive porous material such as carbon paper, and a catalyst layer.

### (Catalyst Layer)

A catalyst layer may be formed by directly applying a catalyst paste that is obtained by mixing catalyst-carrying carbon particles and ionomer of polyelectrolyte in an appropriate solvent, on the surface of the polyelectrolyte membrane. As a method of forming a catalyst layer on the bumpy face of the polyelectrolyte membrane, direct application of a catalyst paste is more preferred than joining by hot pressing or the like. Since the direct application allows the catalyst paste to enter deeply in grooves of the bumpy shape formed in the polyelectrolyte membrane, it is possible to further increase.

Examples of preferred solvents for use in preparation of catalyst paste include water, alcohols, glycerin, tetrahydrofuran, propylene carbonate, dimethoxyethane, acetone, dimethylacetamide, acetonitrile, 1-methyl-2 pyrrolidone and the like solvents and mixture thereof.

As a preferred method of applying a catalyst paste onto the polyelectrolyte membrane, screen printing, methods of using doctor blade and bar coater, spray coating, blush application and the like can be exemplified.

In the solid polyelectrolyte type fuel cell of the present invention, the catalyst layer formed on the bumpy face preferably includes a first catalyst layer formed in contact with the polyelectrolyte membrane, and a second catalyst layer formed to be opposite to the polyelectrolyte membrane via the first catalyst layer. In this case, the first catalyst layer is able to function also as an adhesive layer for good cohesion between the polyelectrolyte membrane and the second catalyst layer. In FIG. 1, description is made for a case where catalyst layers 21, 31 respectively include first catalyst layers 21a, 31a and second catalyst layers 21b, 31b.

The electrolytes contained in the first catalyst layer and the second catalyst layer are preferably of the same kind, because better cohesion between the first catalyst layer and the second catalyst layer is realized.

As a method of forming the second catalyst layer on the first catalyst layer, a method of directly applying a required amount of catalyst paste on the first catalyst layer, followed by drying can be exemplified. However, the larger the thickness of the catalyst layer, the more cracking or peeling is likely to occur in the catalyst layer. Therefore, it is more preferred to apply a necessary amount of catalyst paste containing catalyst-carrying carbon particles and ionomer of polyelectrolyte on a conductive porous member such as carbon paper or on a Teflon (registered trademark) resin substrate, followed by drying, and to hot press the resultant dried member to make a second catalyst layer. Since the surface of the first catalyst layer substantially reflects the shape of the bumpy face formed in the polyelectrolyte membrane, the contact area between the first catalyst layer and the second catalyst layer is large, and the first catalyst layer and the second catalyst layer can be joined with high cohesion.

In the solid polyelectrolyte type fuel cell of the present invention, the catalyst layer formed on the bumpy face of the polyelectrolyte membrane preferably contains catalyst-carrying carbon particles having surfaces modified with a proton dissociative functional group or an organic compound having a proton dissociative functional group.

A catalyst layer used in the solid polyelectrolyte type fuel cell typically contains a catalyst, and an electrolyte realized by ion exchange resin such as polyelectrolyte ionomer or the like. The electrolyte contributes to ensure proton conductivity inside the catalyst layer. In a catalyst layer formed, for example, by mixing catalyst-carrying carbon particles with an electrolyte, part of the surface of the catalyst-carrying carbon particles may not be uncovered. In particular, it is generally difficult for the electrolyte to enter inside micropores in the order of nanometer in catalyst-carrying carbon particles.

By modifying the surface of catalyst-carrying carbon particles with a proton dissociative functional group or an organic compound having the proton dissociative functional group, it is possible to make the electrolyte enter inside the micropores of the catalyst-carrying carbon particles. Therefore, in this case, proton conductivity in the catalyst layer is improved, and by increasing the surface area of the catalyst contributing to reaction at electrodes, it is possible to improve current density per unit area of electrode, and to improve power generation characteristic of the fuel cell.

When the catalyst-carrying carbon particles subjected to surface modification are formed in such a manner that they are in contact with the polyelectrolyte membrane, proton conductivity is particularly excellent in the vicinity of the surface of the polyelectrolyte membrane. Therefore, in this case, it is possible to further decrease the proportion of electrolyte in the catalyst layer, and hence to allow more catalyst-carrying carbon particles to enter grooves in the bumpy face of the polymer solid electrolyte membrane. This makes it possible to reduce the thickness of catalyst layer required for obtaining desired power generation characteristics, and enables reduction in production cost and further miniaturization of the fuel cell.

When the catalyst paste containing the catalyst-carrying carbon particles subjected to surface modification is directly applied onto the polyelectrolyte membrane and dried, cohesion between the catalyst layer and the polyelectrolyte membrane increases, and proton conductivity between the catalyst layer and the polyelectrolyte membrane improves, so that the effect of improving characteristics of electrodes is achieved more significantly.

In the solid polyelectrolyte type fuel cell of the present invention, when the catalyst layer formed on the bumpy face of the polyelectrolyte membrane includes a first catalyst layer formed in contact with the polyelectrolyte membrane, and a second layer formed to be opposite to the polyelectrolyte membrane via the first catalyst layer, it is preferred that only the first catalyst layer of the first catalyst layer and the second catalyst layer contains the catalyst-carrying carbon particles subjected to surface modification. In this case, excellent gas diffusivity is ensured even when such a large thickness as not less than 15 μm is required for the catalyst layer such large in order to increase the quantity of catalyst in electrodes.

When the surface of the catalyst-carrying carbon particles in the first catalyst layer is modified as described above and the surface of the catalyst-carrying carbon particles in the second catalyst layer is not modified as described above, the thickness of the first catalyst layer is preferably not more than 15 nm. When the thickness is not more than 15 μm, flooding in which generated water accumulates is difficult to occur, so that electromotive force is less likely to drop.

On the other hand, larger thickness is preferred for the second catalyst layer from the view point of promoting gas diffusivity, and the thickness preferably falls within the range of 50 μm to 500 μm, and more preferably about 100 Gum. When thickness of the second catalyst layer is not less than 50 μm, gas diffusivity is desirably ensured and excellent current density is obtained. When the thickness is not more than 500 μm, there is less possibility that handling is complicated due to cracking or peeling of the catalyst layer. However, the thickness of the second catalyst layer may exceed 500 μm provided that such catalyst layer can be produced and there is no limitation for the size.

In the present invention, when problems of cracking, peeling and the like do not particularly arise in the catalyst layer, it is preferred to form a catalyst layer exclusively including the catalyst layer subjected to surface modification as described above. In this case, since the surface area of the catalyst that contributes to reaction in electrodes can be increased, power generation characteristics of the fuel cell is particularly good. In this case, thickness of the catalyst layer subjected to surface modification may be about several hundreds of micrometers, for example.

The catalyst layer made up of the first catalyst layer and the second catalyst layer may be formed, for example, by joining the second catalyst layer on the first layer by thermocompression bonding or the like after forming the first catalyst layer. Forming the second catalyst layer on the first catalyst layer by thermocompression bonding is preferred because the fuel cell can be produced more easily. The first catalyst layer and the second catalyst layer may be formed so that they are in direct contact with each other, however, other substance such as an electron collector substance may be interposed between the first catalyst layer and the second catalyst layer.

The catalyst-carrying carbon particles used in the present invention are typically carbon particles that carry catalyst metal as a catalyst. Any carbon particles can be used as far as certain properties are achieved, and carbon blacks such as furnace black, acetylene black, and Ketjen black, active carbon, graphite, carbon fiber, carbon nano tube and the like can be exemplified. These may be used solely or in a mixture of two or more kinds.

In the present invention, when the catalyst-carrying carbon particles having surfaces modified with a proton dissociative functional group or an organic compound having a proton dissociative functional group are used, the specific surface area of the catalyst-carrying carbon particles subjected to surface modification is preferably not less than 800 m²/g, and more preferably in the range of 800 to 2000 m²/g.

For improving power generation characteristics of the fuel cell, it is effective to improve the use efficiency of catalyst in reaction at electrodes by increasing the specific surface area of the catalyst. For increasing the specific surface area of the catalyst, it is effective to increase the specific surface area of the catalyst-carrying carbon particles. The larger the specific surface area of the catalyst-carrying carbon particles, in the smaller size the catalyst is microparticulated and carried in, and the specific surface area of the catalyst increases. Preferably, the catalyst is microparticulated into about several nanometers, for example.

When the specific surface area of the catalyst-carrying carbon particles subjected to surface modification is not less than 800 m²/g, the effect of improving the use efficiency of the catalyst is desirably obtained because of the enlarged specific surface area of the catalyst. However, when the specific surface area of the catalyst-carrying carbon particles exceeds 1000 m²/gm, particularly 2000 m²/g, the catalyst performance tends to gradually decrease. In brief electron transfer efficiency gradually decreases due to increase in electric resistance of the carrier, and electrolyte membrane is difficult to enter because of growing of micropores of the carrier. This may cause the tendency of decrease in ion conductivity. Therefore, the specific surface area is preferably not more than 2000 m²/g, and more preferably not more than 1000 m²/g.

In order to obtain the catalyst-carrying carbon particles having specific surface areas adjusted as described above, the specific surface areas of the carbon panicles which are carries is preferably not less than 800 m²/g, and more preferably in the range of 800 to 2000 m²/g.

The specific surface area described herein refers to a value measured by using the BET method.

As the carbon particles, a commercially available product or those produced by using a known method may be used. The specific surface areas of carbon particles may be adjusted by subjecting commercially available carbon particles to physical or chemical treatment. For example, the specific surface areas of carbon particles can be increased by subjecting the carbon particles to a liquid-phase oxidization treatment or a vapor deposition treatment.

Catalyst metal carried on the carbon particles is not particularly limited insofar as it provides specific characteristics, however, it is preferably platinum, ruthenium, rhodium, iridium, palladium, osmium or the like noble metal, or alloy of such metal. In the present invention, catalyst metal is preferably dispersed in the form of particles on carbon particles. To be more specific, catalyst metal can be carried on the carbon particle carrier by reducing a complex containing the catalyst metal while the complex containing the catalyst metal is mixed with the carbon particles.

Quantitative proportion of carried catalyst metal, with respect to a mass of carbon particles is preferably 20 to 60% by mass. When the proportion is not less than 20% by mass, the surface area of the catalyst is desirably ensured, and when the proportion is not more than 60% by mass, it is possible to prevent the particle sizes of the catalyst metal from becoming too large.

### (Surface Modification of Catalyst Layer)

The catalyst layer formed in the present invention preferably contains catalyst-carrying carbon particles having surfaces modified with a proton dissociative functional group or an organic compound having a proton dissociative functional group. Typically, catalyst-carrying carbon particles subjected to surface modification can be formed by causing catalyst metal to be carried on the carbon particles after modifying the surface of carbon particles which are carrier of catalyst metal.

As a proton dissociative functional group, a carboxyl group, a sulfonate group, a phosphate group and the like can be exemplified, and in particular, sulfonate group is preferred. Carboxyl group, sulfonate group and phosphate group, in particular, sulfonate group are preferred in that they can be readily introduced into catalyst-carrying carbon particles by general organic chemical reaction.

When the surface is modified with a sulfonate group, sulfuric acid, fuming sulfuric acid, sulfur trioxide, chlorosulfuric acid or fluorosulfuric acid may be used as a sulfonating reagent.

As an organic compound having a proton dissociative functional group, those having a sulfonate group as a proton dissociative functional group, such as sodium styrene sulfonate, chlorosulfuric acid, ammonia persulfate and the like, and those having a phosphate group as a proton dissociative functional group, such as inositol monophosphate, tetracalcium phosphate, calcium hydrogen phosphate and the like can be recited.

In the present invention, a method of modifying with a carboxyl group by plasma burning or UV treatment using oxygen gas may be employed.

Prior to surface modification with a proton dissociative functional group, carbon particles are preferably subjected to surface treatment such as ozone treatment, plasma treatment, liquid phase oxidation treatment, vapor treatment or fluorine treatment. As a result, a reactive group such as hydroxy group or the like is formed on the carbon particles. In such a case, by allowing the reactive group to chemically react with an organic compound having a proton dissociative functional group, it is possible to readily introduce the proton dissociative functional group onto the carbon particles.

Further, by controlling the degree of the surface treatment described above, it is possible to control the density of generating reactive group, and as a result, it is possible to control the density of proton dissociative functional group on the carbon particles. As a result, it is possible to readily introduce the proton dissociative functional group onto the carbon particles at desired density, and to readily impart high catalyst performance.

### (Diffusion Layer)

As a diffusion layer, those generally used as a diffusion layer of fuel cell such as carbon paper, carbon cloth and the like may be appropriately formed and also porous members altered to have conductivity, such as polyaniline-added ceramics, and metal wool altered to have oxidation resistance, such as steel wool treated with carbide may be used. In such a structure in which fuel diffuses sufficiently to the catalyst layer, the diffusion layer may not be used.

### <Polyelectrolyte Membrane>

The polyelectrolyte membrane used in the present invention is a solid polyelectrolyte membrane, and concrete examples include electrolyte membranes formed exclusively of solid polymer, and solid complex membranes formed of polyelectrolyte and inorganic electrolyte. Examples of electrolyte membranes formed of solid polymer include perfluoro sulfonate membrane, and proton conductive electrolyte membranes formed of hydrocarbon membranes of sulfonated aromatic polyether ketone, polybenzoimidazole, polyamide, and the like. As an inorganic electrolyte membrane, an inorganic glass electrolyte membrane obtained by using a sol-gel method can be exemplified.

In the present invention, surface roughness of the bumpy face of the polyelectrolyte membrane is preferably not less than 1 μm by average roughness (Ra). When the average roughness (Ra) is not less than 1 μm, contact area between the catalyst layer and the polyelectrolyte membrane is large, and cohesion between the electrode and the polyelectrolyte membrane is particularly good. The average roughness is preferably not less than 100 μm, and more preferably not less than 200 μm.

When the average roughness (Ra) of the bumpy face of the polyelectrolyte membrane is too large, the contact area between the catalyst layer and the polyelectrolyte membrane is small, and a gap is more likely to occur between the catalyst layer and the polyelectrolyte membrane. Therefore, the average roughness is preferably not more than 500 μm, more preferably not more than 400 μm, and still preferably not more than 300 μm, for example.

Standards for surface roughness are defined, for example, by JIS (Japanese Industrial Standards), and average roughness (Ra) is measurable, for example, with an atomic force microscope (AFM).

### [Production Method of Solid Polyelectrolyte Type Fuel Cell]

The present invention also provides a method of producing the solid polyelectrolyte type fuel cell described above, which includes: a bumpy face forming step that forms a bumpy face on at least one surface of the polyelectrolyte membrane; an applying step that directly applies a catalyst paste containing catalyst-carrying carbon particles onto at least the bumpy face in the polyelectrolyte membrane; and a drying step that dries the catalyst paste to form a catalyst layer containing the catalyst-carrying carbon particles. By directly applying the catalyst paste containing catalyst-carrying carbon particles to the polyelectrolyte membrane, followed by drying, it is possible to make the catalyst layer enter to the bottom of grooves in the bumpy face formed in the polyelectrolyte membrane. Therefore, according to the production method of the present invention, it is possible to improve contact area and cohesion between the catalyst layer and the polyelectrolyte membrane.

### <Bumpy Face Forming Step>

In the method of producing a solid polyelectrolyte type fuel cell according to the present invention, a bumpy face having a bumpy shape is formed on least one surface of the polyelectrolyte membrane. As a measure for making the bumpy shape, a method of polishing the surface of the polyelectrolyte membrane with polishing paper or fiber, a method of making sandy particles into collision with the surface of the polyelectrolyte membrane, methods based on ion irradiation and plasma treatment, and a method of pressing the polyelectrolyte membrane with a metal plate having a bumpy shape can be used.

### <Catalyst-Carrying Carbon Particles Preparing Step>

Catalyst-carrying carbon particles may be prepared, for example, by dipping and stirring carbon particles in a catalyst metal solution, and causing catalyst metal ion in the solution to reductively precipitate on the carbon particles by heating or by adding a reducing agent such as sodium tetrahydroborate. As a catalyst metal solution, for example, a dinitro-ammine platinum nitric acid solution, a platinum tetra-ammine complex solution, a platinum chloride acid solution, a platinum carbonyl complex solution and the like may be used. The catalyst may not be platinum, and platinum ruthenium, gold, gold palladium and the like platinum alloy, noble metal simple substance, noble metal alloy and the like may be used. In such a case, catalyst-carrying carbon particles may be prepared by individual reduction or simultaneous reduction using the above platinum solution, chlorides of metals and the like.

### <Applying Step>

In the applying step, a catalyst paste containing catalyst-carrying carbon particles is directly applied onto at least the bumpy face of the polyelectrolyte membrane formed with the bumpy face as described above. The catalyst paste may be prepared, for example, by dispersing catalyst-carrying carbon particles into solvent such as water, alcohols, glycerin, tetrahydrofuran, propylene carbonate, dimethoxyethane, acetone, dimethyl acetamide, acetonitrile, 1-methyl-2 pyrrolidone, or mixture thereof.

Preferred methods of applying a catalyst paste to a polyelectrolyte membrane include screen printing, methods using a doctor blade and a bar coater, spray coating, application with brush and the like.

### <Drying Step>

The catalyst paste applied onto the polyelectrolyte membrane as described above is dried to form a catalyst layer containing the catalyst-carrying carbon particles. The drying condition varies in accordance with thickness of catalyst layer, water content, amount of electrolyte and the like. Typically, it may be executed by hot pressing for such a time under such a pressure that will not cause peeling of electrode even when the electrode is dipped in water at a temperature of lower than glass transition point of electrolyte by 5° C.

In the production method of a solid polyelectrolyte type fuel cell according to the present invention, the catalyst layer that is formed by the applying step and the drying step preferably contains catalyst-carrying carbon particles having surfaces modified with a proton dissociative functional group or an organic compound having such a proton dissociative functional group. In this case, by increasing the surface area of catalyst that contributes to reaction at electrode, it is possible to improve characteristics of the fuel cell.

In the production method of a solid polyelectrolyte type fuel cell according to the present invention, it is preferred that the catalyst layer formed on the bumpy face of the polyelectrolyte membrane includes a first catalyst layer that is formed in contact with the polyelectrolyte membrane, and a second catalyst layer that is formed to be opposite to the polyelectrolyte membrane via the first catalyst layer, and that the first catalyst layer is formed by the applying step and the drying step, and that a joining step for joining the second catalyst layer to the surface of the first catalyst layer by thermocompression bonding is further provided. This reduces the risk of cracking and peeling of the catalyst layer, and further facilitates production of the fuel cell.

In this case, a method of overlaying a first catalyst layer with a second catalyst layer that is produced in advance by a method of applying a necessary amount of catalyst paste including catalyst-carrying carbon particles and ionomer of polyelectrolyte on a conductive porous member such as carbon paper or Teflon (registered name) resin substrate, followed by drying, and joining them by heat pressing may be employed.

In the production method of a solid polyelectrolyte type fuel cell according to the present invention, it is preferred that, of the first catalyst layer and the second catalyst layer, only the first catalyst layer contains catalyst-carrying carbon particles having surfaces modified as described above. In this case, the fuel cell can be easily produced. Further, cohesion between the catalyst layer and the polyelectrolyte membrane can be increased, and excellent gas diffusivity is ensured even when the thickness of catalyst layer is large. Therefore, excellent reliability is imparted to the fuel cell.

### EXAMPLES

In the following, the present invention will be described in more detail by way of Examples. However, the present invention will not be limited to thereto. In the following Examples, a specific surface area was measured using a specific surface area measuring device (type BELSORP 18) available from BEL JAPAN, Inc., and a cross section form was observed using a scanning electron microscope (SEM) (type JSM5310-LV) available from JASCO Corporation.

### Example 1

### Fabrication of Polymer Solid Electrolyte Membrane Having a Surface Formed with Bumpy Face

As a polyelectrolyte membrane, Nafion (registered trademark) 117 (available from Du Pont) was used. The polyelectrolyte membrane was sandwiched by two dies having a bumpy shape of surface roughness (Ra) of about 30 μm, and pressed at 100° C. under 5 MPa for 3 minutes. As a result, the bumpy shapes of the dies were transferred on both sides of the polyelectrolyte membrane, and a bumpy face having surface roughness of about 10 μm was formed on the surface of the polyelectrolyte membrane.

<Surface Modification with Proton Dissociative Functional Group>

Carbon black (acetylene black) having a specific surface area of 1120 m/g was suspended in a solution of 2 (4-chlorosulfonylphenyl)ethyltrichlorosilane in dichloromethane, and stirred for 2 hours at room temperature. Next, the suspension was filtered and dried under reduced pressure. In this manner, carbon particles having surfaces modified with a proton dissociative functional group were obtained.

### <Carrying of Platinum on Carbon Particles>

3 g of the aforementioned carbon particles subjected to surface modification were dipped and stirred in 90 g of 2.2% by mass of dinitrodiammine platinum nitric acid solution. The carbon particles were caused to carry 50% by mass of platinum, relative to mass of the carbon particles by adding 10 mL of ethanol, and stirring for 6 hours at 95° C., to obtain catalyst-carrying carbon particles.

### <Production of Fuel Cell>

The catalyst-carrying carbon particles obtained as described above were adjusted and dispersed by sonication so that the mass ratio between catalyst-carrying carbon particles Naofin (registered trademark) was 7:3 by a Naofin (registered trademark) dispersed solution, to thereby produce a catalyst paste. The catalyst paste was directly applied onto the polyelectrolyte membrane having a bumpy face fabricated as described above, and dried, to form a catalyst layer. This step was conducted on both sides of the polyelectrolyte membrane, to thereby produce a joined member.

The cross section form of the joined member was observed by a scanning electron microscopy (SEM) to reveal that the catalyst-carrying carbon particles have entered the entire bottom of the bumpy shape of the bumpy face.

Next, the joined member obtained as described above was hot pressed at 130° C. for 3 minutes while being sandwiched on both sides by water-repellent carbon paper, to form diffusion layers of carbon paper. Then the resultant structure was held by a pair of separators, to produce a solid polyelectrolyte type fuel cell having a single as shown in FIG. 1 was produced. Here, the water-repellent carbon paper was manufactured by applying a paste in which mixture of carbon black and polytetrafluoroethylene (PTFE) was dispersed uniformly in ethylene glycol, on one side of carbon paper (TORAY, TPG-H-060), followed by drying.

### Comparative Example 1

As the polyelectrolyte membrane, polyelectrolyte membrane having a bumpy face fabricated in a similar manner as described in Example 1 was used. Catalyst-carrying carbon particles not subjected to surface modification were mixed with Naofin (registered trademark) dispersed solution at a mass ratio which is similar to that of Example 1, and dispersed by sonication, to give a catalyst paste. The catalyst paste was directly applied onto the polyelectrolyte membrane and dried, to form a catalyst layer. The subsequent steps were conducted in a similar manner as described in Example 1, to produce a solid polyelectrolyte type fuel cell having a single cell.

### Comparative Example 2

A solid polyelectrolyte type fuel cell having a single cell was produced by similar steps as described in Example 1 except that a bumpy face was not formed in the polyelectrolyte membrane.

### Comparative Example 3

As the polyelectrolyte membrane, a polyelectrolyte membrane having a bumpy face, fabricated by a process which is similar to that of Example 1 was used. A catalyst paste that was prepared by a method similar to that in Example 1 was applied onto water-repellent carbon paper, to manufacture an electrode for a fuel cell formed with a catalyst layer.

A polyelectrolyte membrane was sandwiched between two electrodes for a fuel cell obtained as described above so that the respective catalyst paste sides were opposite to the polyelectrolyte membrane, and integrated by hot pressing at 130° C. for 3 minutes, to give a joined member. Cross section form of the joined member was observed by a scanning electron microscopy (SEM).

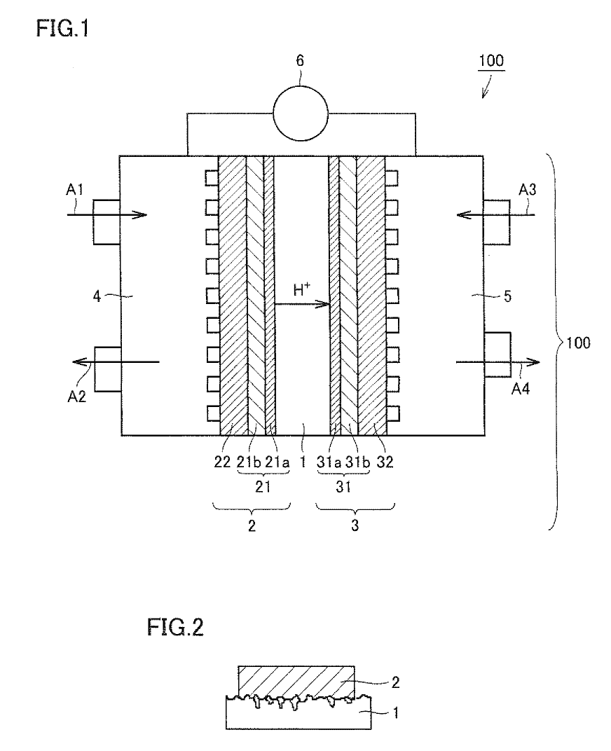

FIG. 2 is a schematic view of a cross section form of the joined member observed in Comparative Example 3. As shown in FIG. 2, in the joined member fabricated in Comparative Example 3, a part where catalyst-carrying carbon particles failed to enter the bottom of groove was observed in a part of the bumpy face in the polyelectrolyte membrane.

The joined member obtained as described above was sandwiched between a pair of separators as shown in FIG. 1 to produce a solid polyelectrolyte type fuel cell having a single cell,

### [Measurement of Cell Voltage]

The solid polyelectrolyte type fuel cells obtained in Example 1 and Comparative Examples 1 to 3 were subjected to power generation test by supplying moisturized hydrogen to the anode side, and moisturized air to the cathode side.

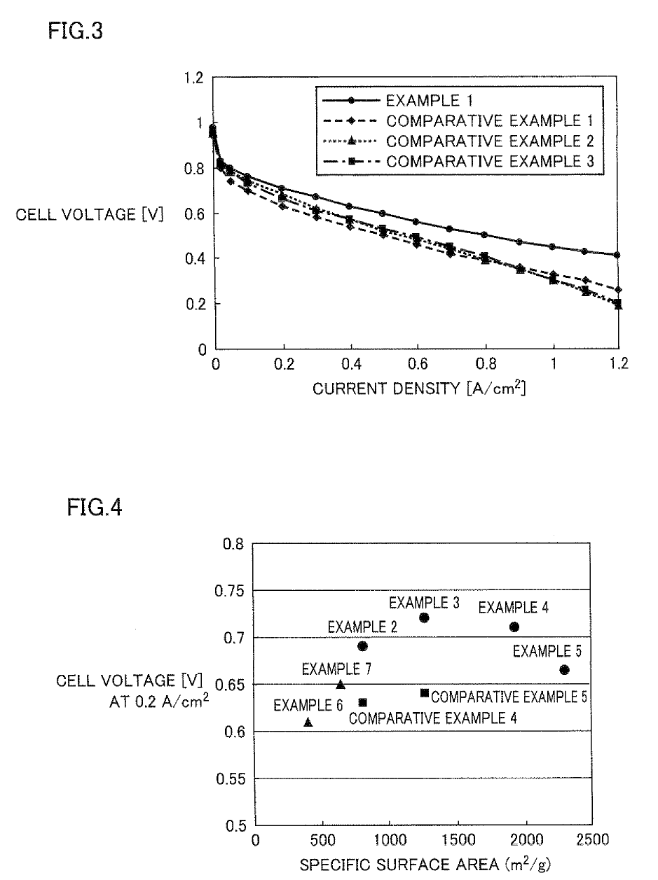

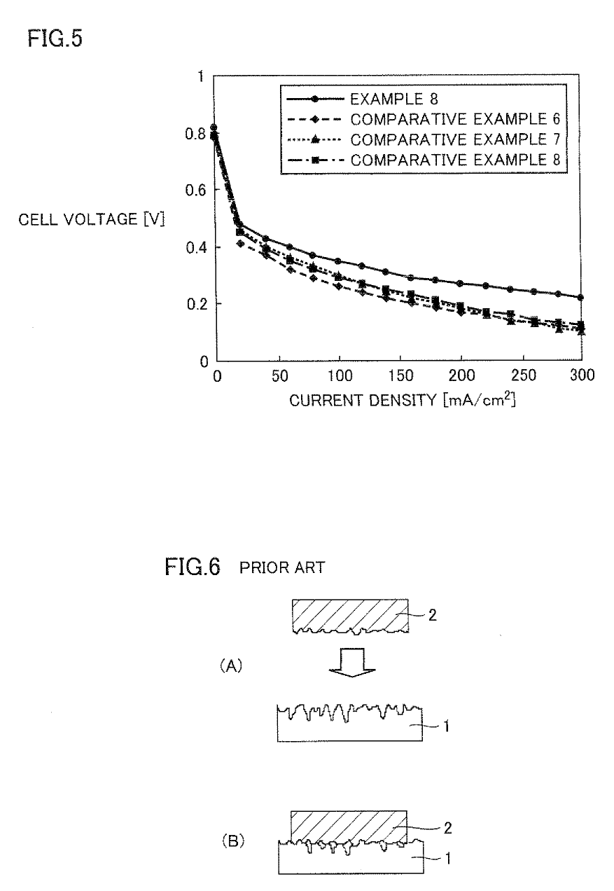

FIG. 3 shows results of power generation tests for the solid polyelectrolyte type fuel cells obtained in Example 1 and Comparative Examples 1 to 3. According to FIG. 3, Example 1 in which the catalyst layer was formed so that catalyst-carrying carbon particles enter the bottom of the bumpy shape of the bumpy face formed in the polyelectrolyte membrane showed a better cell voltage compared to Comparative Examples 1 to 3. The low cell voltage in each Comparative Example is attributable to poor cohesion between the catalyst layer and the polyelectrolyte membrane for Comparative Example 1; small contact area between the catalyst layer and the polyelectrolyte membrane for Comparative Example 2; and generation of gap between the catalyst layer and the polyelectrolyte membrane for Comparative Example 3. This demonstrates that a solid polyelectrolyte type fuel cell having high power generation performance can be produced according to the present invention.

### Examples 2 to 5

Solid polyelectrolyte type fuel cells were produced in a similar manner as described in Example 1 except that carbon blacks having a specific surface area of 810 m²/g (Example 2), 1270 m²/g (Example 3), 1925 m²/g (Example 4), and 2300 m²/g (Example 5), respectively were used as carbon black.

### Examples 6 and 7

Solid polyelectrolyte type fuel cells were produced in a similar manner as described in Example 1 except that carbon blacks having a specific surface area of 396 m²/g (Example 6), and 643 m²/g (Example 7), respectively were used as carbon black.

### Comparative Examples 4 and 5

Solid polyelectrolyte type fuel cells were produced in a similar manner as described in Example 1 except that carbon blacks not subjected to surface modification having a specific surface area of 810 m²/g (Comparative Example 4), and 1270 m²/g (Comparative Example 5), respectively were used as carbon particles.

### [Measurement of Cell Voltage]

Cell voltages were measured for solid polyelectrolyte type fuel cells obtained in Examples 2 to 7, and Comparative Examples 4 and 5 in a similar manner as described in Example 1.

FIG. 4 is a view showing results of power generation test for solid polyelectrolyte type fuel cells produced in Examples 2 to 7 and Comparative Examples 4 and 5, FIG. 4 shows the relationship between the specific surface area of carbon black, and cell voltage when current density is 0.2 A/cm². FIG. 4 demonstrates that catalyst performance can be greatly improved at the specific surface area of carbon black of not less than 800 m²/g, and particularly high cell voltage is realized. Low cell voltages in Comparative Examples 4 and 5 are attributable to the fact that the catalyst layer is not in close contact with the polyelectrolyte membrane.

### Example 8

As a polyelectrolyte membrane, a polyelectrolyte membrane having a bumpy face, fabricated in a similar process as described in Example 1 was used.

Using carbon black (acetylene black) having a specific surface area of 1120 m²/g as carbon particles, azo group was introduced to the surface of the carbon particles by a method of heating under reflux with benzene diazonium chloride, and graftation of polystyrene was conducted on the surface of the carbon particles by adding styrene. Next, carbon particles were suspended in 5% by mass of sulfur trioxide solution, and stirred for 4 hours at 120° C. Then, this was filtered and dried under reduced pressure. In this manner, carbon particles having surfaces modified with an organic compound having a proton dissociative functional group were obtained.

### <Carrying of Catalyst Metal on Carbon Particles>

7 g of the aforementioned carbon particles subjected to surface modification in the above were dipped and stirred in 90 g of 2.2% by mass of dinitrodiammine platinum solution in nitric acid. This was then added with 10 mL of ethanol and stirred for 6 hours at 95° C. to make the carbon particles carry platinum. As a result, platinum-carrying surface modified carbon particles in which 50% by mass, relative to mass of carbon particles, of platinum was carried on the carbon particles were obtained.

The platinum-carrying carbon particles were further made to carry ruthenium by addition of 10 g of 5, 2% by mass of the ruthenium chloride solution, followed by stirring. As a result, platinum ruthenium alloy-carrying surface-modified carbon particles in which 50% by mass, relative to mass of carbon particles, of platinum ruthenium alloy is carried on the carbon particles were obtained.

### <Production of Fuel Cell>

Next, the platinum-carrying surface-modified carbon powder obtained as described above serving as catalyst-carrying carbon particles, were mixed with Naofin (registered trademark) dispersed solution so that mass ratio of catalyst-carrying carbon particles and Naofin (registered trademark) was 8.2, and catalyst-carrying carbon particles were dispersed by sonication to prepare a catalyst paste. The catalyst paste was then directly applied on both sides of the polyelectrolyte membrane, and dried to form a joined member in which a first catalyst layer having thickness of about 10 μm was formed.

Using platinum-carrying carbon particles or platinum ruthenium alloy-carrying carbon particles that are prepared in a similar manner as described above except that surface modification was not conducted, as catalyst-carrying carbon particles, the catalyst-carrying carbon particles not subjected to surface modification and Naofin (registered trademark) dispersed solution were mixed so that mass ratio of catalyst carbon particles:Naofin (registered trademark) was 6:4, and the catalyst-carrying carbon particles were dispersed by sonication, to prepare two kinds of catalyst pastes. These were respectively applied on water-repellant carbon paper, to fabricate electrodes for a fuel cell formed with a second catalyst layer.

Using the electrode for a fuel cell formed with a second catalyst layer containing platinum ruthenium alloy-carrying carbon particles obtained as described above on the anode side, and the electrode for a fuel cell formed with a second catalyst layer containing platinum-carrying carbon particles obtained in the above on the cathode side, respectively, the joined member fabricated in the above was sandwiched between the electrodes for a fuel cell, and integrated by hot pressing at 130° C. for 3 minutes. In this manner, an electrode-electrolyte joined member in which second catalyst layers were formed outside the first catalyst layer was produced. Further, this electrode-electrolyte joined member was sandwiched between a pair of separators as shown in FIG. 1, to produce a solid polyelectrolyte type fuel cell having a single cell.

### Comparative Example 6

A solid polyelectrolyte type fuel cell having a single cell was produced in a similar manner as described in Example 8 except that surface modification of carbon particles was not conducted in formation of the first catalyst layer.

### Comparative Example 7

A solid polyelectrolyte type fuel cell having a single cell was produced in a similar manner as described in Example 8 except that the polyelectrolyte membrane was not subjected to process for making a bumpy face.

### Comparative Example 8

A solid polyelectrolyte type fuel, cell having a single cell was produced in a similar manner as described in Example 8 except that a first catalyst layer was not formed.

### [Measurement of Cell Voltage]

For solid polyelectrolyte type fuel cells obtained in Example 8 and Comparative Examples 6 to 8, power generation when used as a direct methanol fuel cell was tested by supplying the anode side with a methanol aqueous solution and supplying the cathode side with air. FIG. 5 shows results of power generation tests for solid polyelectrolyte type fuel cells produced in Example 8 and Comparative Examples 6 to 8. FIG. 5 shows relationship between current density and cell voltage.

FIG. 5 demonstrates that Example 8 shows better cell voltage than Comparative Examples 6 to 8, and is superior in power generation characteristics. This is attributable to the fact that in Example 8, a fuel cell having high performance can be produced by increasing the surface area by making the surface of the polyelectrolyte membrane bumpy, and forming a first catalyst layer by directly applying a catalyst paste using surface-modified catalyst-carrying carbon particles, and then bonding a second catalyst layer applied with catalyst-carrying carbon particles not subjected to surface modification by thermocompression.

The low cell voltage in each Comparative Example is attributable to: lack of contact between the catalyst layer and the polyelectrolyte membrane for Comparative Example 6; small contact area between the catalyst layer and the polyelectrolyte membrane for Comparative Example 7; and generation of gap between the catalyst layer and the polyelectrolyte membrane for Comparative Example 8.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A solid polyelectrolyte type fuel cell comprising a polyelectrolyte membrane and a pair of electrodes sandwiching said polyelectrolyte membrane,
wherein said electrodes have a catalyst layer containing catalyst-carrying carbon particles,
at least one surface of said polyelectrolyte membrane has a bumpy face in which a bumpy shape is formed, and
said catalyst layer is formed in contact with said bumpy shape of said bumpy face.

2. The solid polyelectrolyte type fuel cell according to claim 1, wherein said catalyst layer formed on said bumpy face contains catalyst-carrying carbon particles having surfaces modified with a proton dissociative functional group or an organic compound having said proton dissociative functional group.

3. The solid polyelectrolyte type fuel cell according to claim 2, wherein said catalyst-carrying carbon particles having said surface modification has a specific surface area of not less than 800 m²/g.

4. The solid polyelectrolyte type fuel cell according to claim 1, wherein said catalyst layer formed on said bumpy face includes a first catalyst layer formed in contact with said polyelectrolyte membrane, and a second catalyst layer formed to be opposite to said polyelectrolyte membrane via said first catalyst layer.

5. The solid polyelectrolyte type fuel cell according to claim 4, wherein of said first catalyst layer and said second catalyst layer, only said first catalyst layer contains catalyst-carrying carbon particles having surfaces modified with a proton dissociative functional group or an organic compound having said proton dissociative functional group.

6. The solid polyelectrolyte type fuel cell according to claim 5, wherein a specific surface area of said catalyst-carrying carbon particles subjected to said surface modification is not less than 800 m²/g.

7. The solid polyelectrolyte type fuel cell according to claim 1, wherein surface roughness on said bumpy face of said polyelectrolyte membrane is not less than 1 μm by average roughness (Ra).

8. A method of producing the solid polyelectrolyte type fuel cell according to claim 1, the method comprising:
a bumpy face forming step of forming said bumpy face on at least one surface of said polyelectrolyte membrane;
a catalyst-carrying carbon particles preparing step of preparing catalyst-carrying carbon particles by making carbon particles carry a catalyst;
an applying step of directly applying a catalyst paste containing catalyst-carrying carbon particles to at least said bumpy face of said polyelectrolyte membrane; and
a drying step of drying said catalyst paste to form said catalyst layer containing said catalyst-carrying carbon particles.

9. The method of producing the solid polyelectrolyte type fuel cell according to claim 8, wherein said catalyst layer formed on the bumpy face contains catalyst-carrying carbon particles having surfaces modified with a proton dissociative functional group or an organic compound having said proton dissociative functional group.

10. The method of producing the solid polyelectrolyte type fuel cell according to claim 8, wherein said catalyst layer formed on the bumpy face includes a first catalyst layer formed in contact with said polyelectrolyte membrane, and a second catalyst layer formed to be opposite to said polyelectrolyte membrane via said first catalyst layer, and
said first catalyst layer being formed by said applying step and said drying step,
the method further comprising the step of joining that joins said second catalyst layer to the surface of said first catalyst layer by thermocompression bonding.

11. The method of producing the solid polyelectrolyte type fuel cell according to claim 10, wherein, of said first catalyst layer and said second catalyst layer, only said first catalyst layer contains catalyst-carrying carbon particles having surfaces modified with a proton dissociative functional group or an organic compound having said proton dissociative functional group.
